(19) United States
(12) Patent Application Publication
(10) Pub. No.: US 2006/0143865 A1
(43) Pub. Date: Jul. 6, 2006

(54) Door handle

(75) Inventors: Thomas Magyar, Staufen (DE); Bernd Pfister, Ulm (DE)

Correspondence Address: JOHN T. WINBURN, 100 BOSCH BOULEVARD, NEW BERN, NC, 28562, US

(73) Assignee: BSH Bosch und Stemens Hausgerate GmbH, Munich (DE)

(21) Appl. No.: 10/544,215

(22) PCT Filed: Feb. 24, 2004
(86) PCT No.: PCT/EP04/01811

§ 371 Date: Jul. 29, 2005

(30) Foreign Application Priority Data
Feb. 27, 2003 (DE) 103 08 629.3

(51) Int. Cl. E05B 1/00

(52) U.S. Cl. 16/412

(57) ABSTRACT

The invention relates to a door handle (1) which can be mounted, in particular horizontally on a furniture door (23), in particular refrigeration furniture. The inventive door handle comprises an elongated middle part (2) and two end parts (3, 4) which are fixed to the middle part by a connection in the form of a plug element (21) provided with a receiving element (35). The parts (3, 4) of the door handle extend the middle part (2) in the longitudinal direction thereof. The receiving element (35) comprises a peripherial wall which expands along the entire length thereof. A construction kit for said door handle and a method for the production thereof are also disclosed.

The present invention relates to a door handle for mounting, in particular horizontally on a furniture door, especially a refrigeration furniture door.

Door handles for horizontal mounting on refrigeration furniture doors, such as for example on refrigerator or freezer doors are known from the prior art. For example, DE 197 51 310 A1 describes a one-piece door handle which is combined with a fixing element on the door. Centrally positioning the fixing element on the door should facilitate changing a door stop.

Since the generally convex doors of refrigerator or freezer doors have different widths, depending on the model or manufacturer, door handles of different length must also be manufactured. However, every adaptation of the door handles to a new door width requires considerable technical and therefore financial expenditure.

It is likewise the case with door handles from the prior art that considerable expenditure is involved if design variants are to be produced, especially from different materials. Moulding tools for plastic moulding of such a one-piece door handle are usually specific to the material used, i.e., moulding tools suitable for manufacturing the door handle from a certain plastic composition cannot be used for manufacturing a door handle of the same shape from metal or from another plastic material. Even changing a dye added to the plastic used can result in moulding deviations which make the finished handles unsuitable for their intended function.

More flexible possibilities for shaping the door handle, especially with regard to the choice of material, are obtained with a multi-part door handle according to the preamble of claim 1, as is especially described in DE 196 50 776 A1.

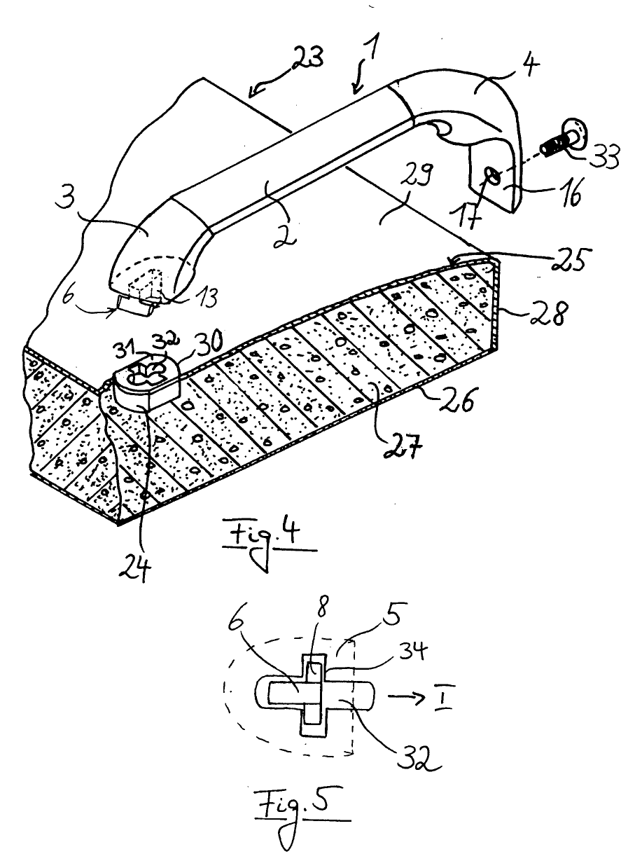

That document describes a door handle with an elongated middle piece and two end pieces which engage in said middle piece and are laterally distant therefrom, which are provided for fixing to a refrigeration furniture door. In particular, FIG. 3 of that document shows an end piece in the form of a cylindrical plug element from which a flat tongue projects radially. The middle piece has a recess complementary to the plug element whose wall is laterally slotted to allow the tongue to pass through. The lateral slot impairs the load-bearing capacity of the middle piece by lateral tension when the door is opened. A more durable handle thus requires a large wall thickness of the sleeve and results in high material costs.

It is thus the object of the invention to provide a door handle for mounting, in particular horizontally on a furniture door, especially a refrigeration furniture door which overcomes the disadvantages of the prior art, and especially combines the creative flexibility of a handle constructed as multi-part with economic use of materials.

This object is solved according to the invention by a door handle comprising an elongated middle piece and two end pieces which are fixed to the middle piece by inserting a plug element into a receiving element of the middle piece, characterised in that the end pieces are attached to the middle piece so that they extend said piece in the longitudinal direction and the receiving element has a continuous peripheral wall over its entire length.

Since, unlike DE 196 50 776 A1, the end pieces each project over the ends of the middle piece, there is no need to slit the peripheral wall of the recess as in that document in order to be able to withdraw the end pieces, i.e. even if, as in that document, the plug element is formed on the end piece and the socket on the middle piece, the middle piece is not weakened by a slit and good strength and load-bearing capacity of the handle can be achieved with a smaller wall thickness of the receiving element.

Since the door handle consists of at least three components, design variants of door handles can be produced simply, for example, by using different materials for the different components. For example, the middle piece can be made of aluminium, stainless steel, plastic or wood. The end pieces can also consist of different materials, wherein plastic, especially PA6 GK30 is preferred since damage to the door panels can thereby be avoided in the mounted state. In addition, the individual components can have different colours.

Such a middle piece can be manufactured simply and cheaply by injection moulding from aluminium or plastic.

It is especially preferable if the middle piece is made from a profile material, especially an extruded profile. It is thereby possible to produce length variants of the door handle, by merely adapting the middle piece to the desired length by cutting suitable lengths from the profile material. The sizes of the end pieces can remain the same however.

The middle piece is preferably embodied as substantially hollow. This brings a significant saving of material, for example, despite high stability.

In an especially preferred embodiment of the door handle according to the invention, the middle piece has a straight profile and is not bent. This effects considerable advantages when assembling the middle piece with the end pieces and reduces the price of the parts since the middle pieces only need to be cut to length and not bent.

One of the receiving elements is preferably provided on the middle piece and a plug element complementary thereto is provided on one of the end pieces. Especially if the middle piece is a hollow profile, the interior cavity can form such a socket.

Conversely it would also be feasible to equip the end pieces with recesses to receive ends of the middle piece. If these ends are not visible on the assembled handle, no stringent requirements need to be imposed on the accuracy of the length of the middle piece.

If the plugging direction of plug element and receiving element is parallel to the longitudinal direction of the middle piece, tensile forces exerted by a user on opening the door act transverse to the plugging direction and cause no slippage of the handle pieces relative to one another and no loosening.

The plug element, whether this is formed on the end piece or the middle piece, is preferably surrounded at its base by a circumferential projection. Such a projection can serve as a stop for receiving the respectively other handle piece when the door handle is assembled.

It is also appropriate if the outer contour of the middle piece at one of its longitudinal ends goes over continuously into the outer contour of the end piece adjacent thereto so that the length of the door handle over which said handle can conveniently be grasped with the hand, extends over the length of the middle piece.

In a preferred embodiment of the door handle according to the invention, at least one, preferably one, of the end pieces has a retaining toggle for form-locking connection to the furniture door. This facilitates mounting the handle on the door since the retaining toggle merely needs to be connected to a suitable fixing element on the door (plugged together) on one side. The handle can also easily be removed again as a result of the form-locking connection.

At least one of the end pieces preferably has at least one through hole for inserting at least one fixing means for fixing to the furniture doors. Said fixing means are generally screws.

The invention further relates to an assembly kit for a door handle according to the invention comprising a middle piece and two end pieces. Different design and length variants of handles, especially of handles for refrigerators, can easily be manufactured using this assembly kit.

The invention further relates to a method for manufacturing a door handle according to the invention, wherein the two end pieces and the middle piece are manufactured separately and then joined together and the length of the handle is determined by the length of the middle piece which is produced by cutting to length, e.g. by sawing to length, from a starting material. The starting material generally already has the cross-sectional shape of the middle piece so that after cutting the desired middle piece to length, no further aftertreatments are required.

Further features of the invention are obtained from the following description of preferred embodiments of the invention in conjunction with the drawings and dependent claims. In this connection individual features can be realised in each case by themselves or in combination with one another.

In the drawings:

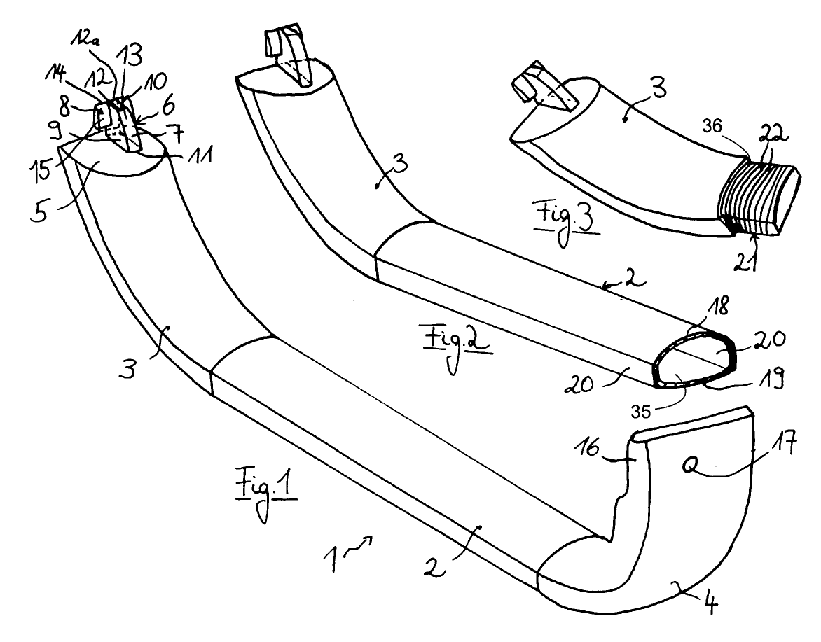

FIG. 1. is a perspective view of an embodiment of a door handle according to the invention,

FIG. 2. is a perspective view of a middle piece of a door handle according to the invention which is joined to an end piece,

FIG. 3. is a perspective view of an end piece of a door handle according to the invention,

FIG. 4. is a perspective view of a section of a refrigerator door with a fixing element fixed on the front for holding the door handle according to the invention released from its fixing position,

FIG. 5. is a schematic diagram of a plan view of the opening of the fixing element from FIG. 4 with retaining toggle inserted.

FIG. 1 shows a perspective view of an embodiment of a door handle 1 according to the invention. The door handle shown has a middle piece 2 which exhibits a straight profile. The middle piece 2 is frictionally connected at its ends to respectively one end piece 3, 4. In this situation, the middle piece 2 and the two end pieces 3, 4 end flush with one another, i.e. they go over into one another without any discontinuity of their cross-sectional shape.

The end piece 3 has a bent profile and encloses an obtuse angle with the middle piece 2. The end of the end piece 3 facing away from the middle piece 2 has a flat face 5 having the shape of a rounded plate. This face 5 is arranged substantially parallel to the middle piece 2. The face 5 has a larger area than the cross-sectional surface of the other end of the end portion 3. A retaining toggle 6 for holding the door handle 1 on a door is located relatively at the centre of the face 5. This retaining toggle 6 is joined in one piece to the handle end portion 3 and has a pedestal 7 and a cross-bar 8 which is joined in one piece to the pedestal 7. The pedestal 7 has a rectangular base surface 9 and a top surface 10 running parallel thereto. The top surface 10 is also embodied as rectangular and has the same width but a shorter length than the base surface 9. The narrow edge 11 of the base surface 9 facing the middle piece 2 is connected to the narrow edge 12 of the top surface 10 facing the middle piece 2 by means of the arc-shaped narrow side 13.

The cross-bar 8 connected in one piece to the pedestal 7 has the shape of a wedge. The upper edge 14 of the cross-bar 8 which is the pointed edge of the wedge, partially coincides with the narrow edge 12a of the top surface 10 facing away from the middle piece 2, the edge 14 having approximately three times the length of the narrow edge 12 or 12a so that the edge 14 projects to the left and right from the narrow edge 12a. The cross-bar 8 has a flat front side facing away from the pedestal 7 (not shown in the drawing) and an arc-shaped back side 15 via which the cross-bar 8 is connected to the pedestal 7.

The end piece 4 likewise has a bent profile. The end piece 4 has a flattened area 16 at its end facing away from the middle piece, which has at least one through hole 17 for inserting a fixing means, especially a screw.

In the present exemplary embodiment the end pieces 3, 4 are made of plastic and the middle piece is made of aluminium.

FIG. 2 shows a perspective view of the middle piece 2 of the door handle according to the invention from FIG. 1 which is only connected to one end piece, i.e., to the end piece 3 from FIG. 1.

The middle piece 2 has an internal cavity 35 which serves as a receiving element and is open at the ends. The middle piece has an upper, more curved side 18 and a lower less curved side 19 which are interconnected by the narrow sides 20.

FIG. 3 shows a perspective view of the end piece 3 from FIGS. 1 or 2 in the unmounted state. The end piece 3 has a plug element 21 on the side to be connected to the middle piece, which is offset from the remainder of the end piece 3 by a circumferential projection 36 and thus has a smaller cross-sectional area than the remainder of the end piece 3. This plug element 21 has the same cross-sectional area as the inner cavity 35 of the middle piece 2 from FIGS. 1 or 2 (more bent upper side, less bent lower side, two connecting narrow sides) so that in the mounted state in FIGS. 1 and 2 the circumferential projection 36 is completely covered by the middle piece 2 and the handle pieces 2, 3 adjoin one another without any discontinuity of the cross-section. As a result of the congruence of the plug element 21 and cavity 35, the plug element 21 can be pressed into the cavity 35 of the middle piece 2 which serves as receiving element, producing a force-locking connection. Furthermore, the insertion section 21 has a scoring 22 which strengthens the force-locking connection.

FIG. 4 shows a perspective view of a section of a refrigerator door 23 with a fixing element 24 fixed on the front for holding the door handle 1 according to the invention released from its fixing position.

The refrigerator door 23 has an outer cladding 25 which forms the outer casing of the door 23 which serves as the visible surface. In addition, the door 23 is provided with an inner cladding 26 on its side facing the refrigerating compartment and adjacent to this is a foamed heat-insulating layer 27.

On its side faces 28 which run vertically in the mounted state of the door 23, the outer cladding 25 is provided with a fixing receiving element, which is not shown in the drawing and which is embodied, for example, as a strengthened thread passage. The outer cladding 25 is further equipped with an oval opening 30 on its front side 29. The opening 30 serves to receive a fixing element 24 similar to a hollow body, which projects into the heat-insulating layer 27 and which is fixed in the opening 30 both by the heat-insulating layer 27 and by measures not shown in a form- and force-locking fashion. In the mounted state the fixing element 24 ends with the outside of its cover 31 flush with the front side 29 of the outer cladding 25. The cover is provided with a cross-shaped opening 32 which serves to receive the retaining toggle 6 and thus to hold the handle 1. In this exemplary embodiment the shape, length and width of the retaining toggle 6 are such that it can be inserted into the opening 32 with little play and can then be displaced in the fixing element 24 parallel to the front side 29 until the cross-bar 8 of the toggle 6 comes out of coincidence with the opening so that a form-locking connection can be produced. The arc-shaped narrow side 13 is used for easier insertion of the retaining toggle 6 into the opening 32 since the retaining toggle 6 can slide along the arc-shaped narrow side 13 at the edge of the opening 32 into said opening.

It is to be understood that various forms of retaining toggles and suitable fixing elements can be provided here to achieve a form-locking connection. It can also be envisaged that the fixing element is provided with a fixing receiver for inserting a threaded screw which passes through the end piece 3 and can penetrate into the fixing receiver.

The end piece 4 is embodied as bent and is provided with a flattened area 16 running substantially perpendicular to the middle piece 2 which serves as a contact face for fixing the door handle 1 on the side face 28. The flattened area has a through hole 17.

For fixing the door handle 1 onto the door 23 the retaining toggle 6 is first inserted into the fixing element 24 and connected thereto in a form-locking fashion by a mechanism described with reference to FIG. 5.

For further holding and final fixing of the door handle 1 on the door 23, a fixing screw 33 is inserted into the through hole 17 and can engage in a fixing receiver embodied as a nut thread on the side face 28, whereby the end piece 4 is not only fixed three-dimensionally on the side face 28 but the retaining toggle 6 is also prevented from becoming released from its positive contact.

FIG. 5 is a schematic diagram showing a plan view of the opening 32 of the fixing means 24 with the retaining toggle 6 inserted. For final form-locking fixing of the door handle 1 in the fixing element 24 the door handle is moved in the direction of the arrow I until the cross-bar 8 comes to rest on the boundary 34 of the opening 32.

1-13. (canceled)

14. A door handle for mounting, generally horizontally on a refrigeration furniture door, comprising:
an elongated middle piece;
two end pieces;
a receiving element formed on at least one of said middle piece and said end pieces;
at least two plug elements formed on at least one of said middle piece and said end pieces;
said end pieces fixed to said middle piece by said plug elements inserted into said receiving element on opposite ends of said middle piece; and
said end pieces attached to said middle piece, extending said middle piece in the longitudinal direction and said receiving element has a substantially continuous peripheral wall over its entire length.

15. The door handle according to claim 14, including said middle piece has a substantially straight profile.

16. The door handle according to claim 14, including said middle piece is an injection moulded part.

17. The door handle according to claim 14, including said middle piece is a hollow extruded profile.

18. The door handle according to claim 14, including at least one of said receiving elements is formed on said middle piece and one of said plug elements complementary to said receiving element is formed on one of said end pieces.

19. The door handle according to claim 14, including the plugging direction of said receiving element and said plug element is substantially parallel to the longitudinal axis of said middle piece.

20. The door handle according to claim 14, including said plug element including a base surrounded by a circumferential projection which forms a stop for said receiving element.

21. The door handle according to claim 20, including said plug element including a scoring for frictionally locking said plug element into said receiving element.

22. The door handle according to claim 14, including the outer contour of said middle piece continues substantially continuously into said end pieces.

23. The door handle according to claim 14, including at least one of said end pieces including a retaining toggle for a form-locking connection to the furniture door.

24. The door handle according to claim 14, including at least one of said end pieces including at least one through hole adapted for inserting at least one fixing means for fixing said end piece to the furniture door.

25. An assembly kit for a door handle adapted to be mounted generally horizontally on a refrigeration furniture door, said kit comprising:
an elongated middle piece;
two end pieces;
a receiving element formed on at least one of said middle piece and said end pieces;
at least two plug elements formed on at least one of said middle piece and said end pieces;
said end pieces adapted to be fixed to said middle piece by said plug elements;
said plug elements adapted to be inserted into said receiving element on opposite ends of said middle piece; and
said end pieces when attached to said middle piece, extending said middle piece in the longitudinal direction. and said receiving element has a substantially continuous peripheral wall over its entire length.

26. The assembly kit according to claim 25, including said middle piece is a hollow extruded profile and including at least one of said receiving elements is formed on said middle piece and one of said plug elements complementary to said receiving element is formed on one of said end pieces.

27. The assembly kit according to claim 25, including at least one of said end pieces including a retaining toggle for a form-locking connection to the furniture door.

28. The assembly kit according to claim 25, including at least one of said end pieces including at least one through hole adapted for inserting at least one fixing means for fixing said end piece to the furniture door.

29. A method for producing a door handle, comprising:
forming a profile strand and cutting a pre-determined length from said profile strand forming an elongated middle piece;
forming two end pieces by individually molding each of said end pieces;
forming a receiving element on at least one of said middle piece and said end pieces;
forming at least two plug elements on at least one of said middle piece and said end pieces;
fixing said end pieces to said middle piece by inserting said plug elements into said receiving element on opposite ends of said middle piece; and
attaching said end pieces to said middle piece, extending said middle piece in the longitudinal direction and forming said receiving element with a substantially continuous peripheral wall over its entire length.

30. The method according to claim 29, including forming said middle piece with a hollow extruded profile and forming at least one of said receiving elements on said middle piece and forming one of said plug elements complementary to said receiving element on one of said end pieces.

31. The method according to claim 29, including forming a retaining toggle on at least one of said end pieces for a form-locking connection to the furniture door.

32. The method according to claim 29, including forming at least one through hole in at least one of said end pieces adapted for inserting at least one fixing means for fixing said end piece to the furniture door.
